(19) United States
(12) Patent Application Publication
(10) Pub. No.: US 2024/0098852 A1
(43) Pub. Date: Mar. 21, 2024

(54) INDUCTION HEATING COOKTOP

(71) Applicant: LG ELECTRONICS INC., Seoul (KR)

(72) Inventors: Kyunghoon JUNG, Seoul (KR); Euisung KlM, Seoul (KR); Hyunwook MOON, Seoul (KR)

(73) Assignee: LG ELECTRONICS INC., Seoul (KR)

(21) Appl. No.: 18/277,194

(22) PCT Filed: Apr. 9, 2021
(86) PCT No.: PCT/KR2021/004470

§ 371 Date: Aug. 14, 2023

(30) Foreign Application Priority Data
Mar. 9, 2021 (KR) 10-2021-0030918

(51) Int. Cl. H05B 6/06; H05B 6/12

(52) U.S. Cl. CPC H05B 6/062; H05B 6/1236; H05B 2206/02

(57) ABSTRACT

An induction heating cooktop includes a working coil; an inverter including a plurality of switching elements, the inverter being configured to supply current to the working coil; and a controller configured to adjust a dead time of the inverter by changing a duty cycle of each of the plurality of switching in the inverter.

### CROSS-REFERENCE TO RELATED APPLICATIONS

This application is the National Phase of PCT International Application No. PCT/KR2021/004470, filed on Apr. 9, 2021, which claims priority under 35 U.S.C. § 119(a) to Patent Application No. 10-2021-0030918, filed in the Republic of Korea on Mar. 9, 2021, all of which are hereby expressly incorporated by reference into the present application.

### TECHNICAL FIELD

The present disclosure relates to an induction heating cooktop, and more particularly, to an induction heating cooktop capable of heating both a magnetic substance and a non-magnetic substance.

### BACKGROUND ART

Various types of cooking appliances are used to heat food at home or in a restaurant. According to the related art, a gas stove using gas as a fuel has been widely used. However, recently, devices for heating an object to be heated, for example, a cooking container such as a pot, have spread that use electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating body such as silicon carbide to the object to be heated (e.g., a cooking container) through radiation or conduction. In the induction heating method, when high-frequency power having a predetermined intensity is applied to a coil, eddy current is generated in the object to be heated using magnetic fields generated around the coil so that the object to be heated is heated.

In the case of such an induction heating method, there is a problem in that output power varies depending on a material of a cooking container even when the same current is applied to a coil. Specifically, a non-magnetic container has smaller specific resistance in the same operating frequency band due to lower permeability than that of a magnetic container, and thus an output of the non-magnetic container is less than that of the magnetic container.

Thus, a method for improving an output of not only the magnetic container but also the non-magnetic container is required. That is, a cooktop capable of heating both the magnetic container and the non-magnetic container at a high output is required.

### DISCLOSURE OF THE INVENTION

### Technical Problem

An object of the present disclosure is to solve the above problems.

An object of the present disclosure is to provide a cooktop capable of heating both a magnetic container and a non-magnetic container at a high output.

An object of the present disclosure is to minimize a switching loss in a cooktop including a silicon carbide (SiC) element.

An object of the present disclosure is to minimize a heat generation problem of a switching element in a cooktop including a SiC element.

### Technical Solution

A cooktop according to an embodiment of the present disclosure may vary in dead time.

A cooktop according to an embodiment of the present disclosure may vary in dead time according to a driving frequency.

A cooktop according to an embodiment of the present disclosure may vary in dead time according to the type of cooking container.

An induction heating cooktop according to an embodiment of the present disclosure include a working coil, an inverter comprising a plurality of switching elements driven so that current flows through working coil, and a controller configured to adjust a duty of each of the plurality of switching elements, wherein a dead time in which all of the plurality of switching elements are turned off is variable.

The controller may be configured to adjust the dead time based on a driving frequency of the inverter.

The controller may be configured to calculate a preset ratio according to the driving frequency as the dead time.

The controller may be configured to calculate the dead time whenever the driving frequency is changed.

The controller may be configured to set the dead time as the preset dead time when the calculated dead time is less than or equal to a preset minimum dead time.

The controller may be configured to set the dead time as the calculated dead time when the calculated dead time exceeds a preset minimum dead time.

The controller may be configured to adjust the dead time according to types of cooking container.

The controller may be configured to set the dead time as a first value when the cooking container is a first container, and set the dead time as a second value when the cooking container is a second container.

When the first container is made of a magnetic substance, and the second container is made of a non-magnetic substance, the first value may be greater than the second value.

The controller may be configured to allow the dead time to vary so that the dead time decreases as the driving frequency of the inverter increases.

### Advantageous Effects

According to an embodiment of the present disclosure, there may be the advantage of minimizing the switching loss as the dead time varies, in particular, the switching loss that increases as the driving frequency increases.

In addition, according to an embodiment of the present disclosure, since the dead time is variable, the dead time may be too short to reduce the possibility of distortion of the gate voltage waveform due to the influence of the parasitic components, thereby minimizing the problem of inverter driving reliability.

In addition, according to an embodiment of the present disclosure, there may be the advantage in minimizing the heat generation of the switching element as the dead time varies.

### BRIEF DESCRIPTION OF THE DRAWINGS

FIG. 1 is a perspective view illustrating a cooktop and a cooking container according to an embodiment of the present disclosure.

FIG. 2 is a cross-sectional view illustrating the cooktop and the cooking container according to an embodiment of the present disclosure.

FIG. 3 is a circuit diagram of the cooktop according to an embodiment of the present disclosure.

FIG. 4 is a view illustrating output characteristics of the cooktop according to an embodiment of the present disclosure.

FIG. 5 is a view illustrating output characteristics of the cooktop depending on a driving frequency for each type of cooking container.

FIG. 6 is a graph illustrating a drop voltage of an internal diode according to a gate voltage of a SiC element.

FIG. 7 is a view illustrating a dead time section and a reverse current generation section of an inverter according to an embodiment of the present disclosure.

FIG. 8 is a control block diagram of the cooktop according to an embodiment of the present disclosure.

FIG. 9 is a flowchart illustrating an operating method of the cooktop according to a first embodiment of the present disclosure.

FIGS. 10 to 11 are views for explaining an example of a method for calculating a dead time in the cooktop according to the first embodiment of the present disclosure.

FIG. 12 is a flowchart illustrating an operating method of a cooktop according to a second embodiment of the present disclosure.

### MODE FOR CARRYING OUT THE INVENTION

Hereinafter, embodiments relating to the present disclosure will be described in detail with reference to the accompanying drawings. Furthermore, terms, such as a “module” ad a “unit”, are used for convenience of description, and they do not have different meanings or functions in themselves.

Hereinafter, an induction heating cooktop and an operation method thereof according to an embodiment of the present disclosure will be described. For convenience of description, the “induction heating cooktop” is referred to as a “cooktop”.

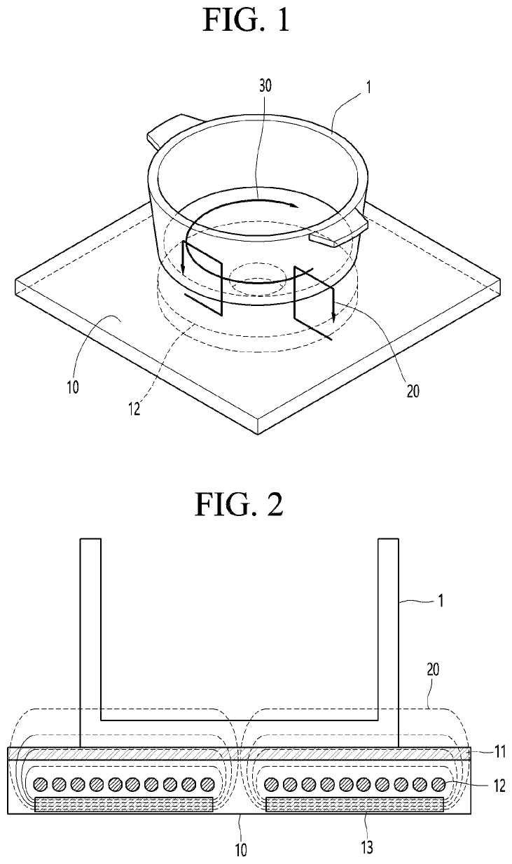

FIG. 1 is a perspective view illustrating a cooktop and a cooking container according to an embodiment of the present disclosure, and FIG. 2 is a cross-sectional view illustrating the cooktop and the cooking container according to an embodiment of the present disclosure.

A cooking container 1 may be disposed above the cooktop 10, and the cooktop 10 may heat a cooking container 1 disposed thereon.

First, a method for heating the cooking container 1 using the cooktop 10 will be described.

As illustrated in FIG. 1, the cooktop 10 may generate a magnetic field 20 via a working coil 12 so that at least a portion of the magnetic field 20 passes through the cooking container 1. Here, if an electrical resistance component is contained in a material of the cooking container 1, the magnetic field 20 may induce an eddy current 30 in the cooking container 1. Since the eddy current 30 generates heat in the cooking container 1 itself, and the heat is conducted or radiated up to the inside of the cooking container 1, contents of the cooking container 1 may be cooked.

When the material of the cooking container 1 does not contain the electrical resistance component, the eddy current 30 does not occur. Thus, in this case, the cooktop 10 may not heat the cooking container 1.

As a result, the cooking container 1 capable of being heated by the cooktop 10 may be a stainless steel container or a metal container such as an enamel or cast iron container.

Next, a method for generating the magnetic field 20 by the cooktop 10 will be described.

As illustrated in FIG. 2, the cooktop 10 may include at least one of an upper plate glass 11, a working coil 12, or a ferrite member 13.

The upper plate glass 11 may support the cooking container 1. That is, the cooking container 1 may be placed on a top surface of the upper plate glass 11.

In addition, the upper plate glass 11 may be made of ceramic tempered glass obtained by synthesizing various mineral materials. Thus, the upper plate glass 11 may protect the cooktop 10 from an external impact.

In addition, the upper plate glass 11 may prevent foreign substances such as dust from being introduced into the cooktop 10.

The working coil 12 may be disposed below the upper plate glass 11. Current may or may not be supplied to the working coil 12 to generate the magnetic field 20. Specifically, the current may or may not flow through the working coil 12 according to on/off of an internal switching element of the cooktop 10.

When the current flows through the working coil 12, the magnetic field 20 may be generated, and the magnetic field 20 may generate the eddy current 30 by interacting with the electrical resistance component contained in the cooking container 1. The eddy current may heat the cooking container 1, and thus, the contents of the cooking container 1 may be cooked.

In addition, heating power of the cooktop 10 may be adjusted according to an amount of current flowing through the working coil 12. As a specific example, as the current flowing through the working coil 12 increases, the magnetic field 20 increases, and thus, since the magnetic field passing through the cooking container 1 increases, the heating power of the cooktop 10 may increase.

The ferrite member 13 is a component for protecting an internal circuit of the cooktop 10. Specifically, the ferrite member 13 serves as a shield to block an influence of the magnetic field 20 generated from the working coil 12 or an electromagnetic field generated from the outside on the internal circuit of the cooktop 10.

For this, the ferrite member 13 may be made of a material having very high permeability. The ferrite member 13 serves to induce the magnetic field introduced into the cooktop 10 to flow through the ferrite member 13 without being radiated. The movement of the magnetic field 20 generated in the working coil 12 by the ferrite member 13 may be as illustrated in FIG. 2.

The cooktop 10 may further include components other than the upper glass 11, the working coil 12, and the ferrite member 13 described above. For example, the cooktop 10 may further include an insulator (not shown) disposed between the upper plate glass 11 and the working coil 12. That is, the cooktop according to the present disclosure is not limited to the cooktop 10 illustrated in FIG. 2.

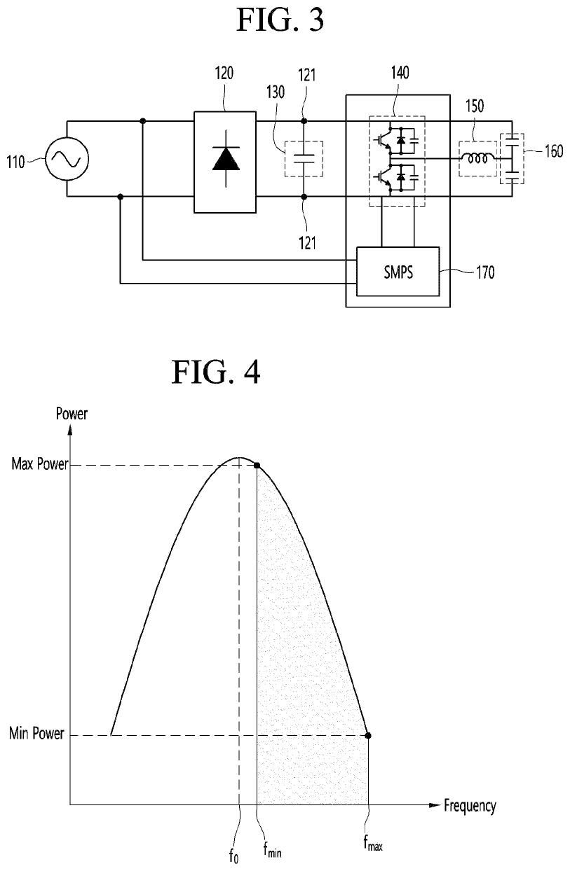

FIG. 3 is a circuit diagram of the cooktop according to an embodiment of the present disclosure.

Since the circuit diagram of the cooktop 10 illustrated in FIG. 3 is merely illustrative for convenience of description, the embodiment of the present disclosure is not limited thereto.

Referring to FIG. 3, the induction heating cooktop may include at least some or all of a power supply 110, a rectifier 120, a DC link capacitor 130, an inverter 140, a working coil 150, a resonance capacitor 160, and a switching mode power supply (SMPS) 170.

The power supply 110 may receive external power. Power received from the outside to the power supply 110 may be alternating current (AC) power.

The power supply 110 may supply an AC voltage to the rectifier 120.

The rectifier 120 is an electrical device for converting alternating current into direct current. The rectifier 120 converts the AC voltage supplied through the power supply 110 into a DC voltage. The rectifier 120 may supply the converted voltage to both DC ends 121.

An output terminal of the rectifier 120 may be connected to both the DC ends 121. Each of both the ends 121 of the DC output through the rectifier 120 may be referred to as a DC link. A voltage measured at both the DC ends 121 is referred to as a DC link voltage.

A DC link capacitor 130 serves as a buffer between the power supply 110 and the inverter 140. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 may include a semiconductor switch, and the semiconductor switch may be an insulated gate bipolar transistor (IGBT) or a SiC element. Since this is merely an example, the embodiment is not limited thereto. The inverter 140 drives the semiconductor switch to allow the high-frequency current to flow in the working coil 150, and thus, high-frequency magnetic fields are generated in the working coil 150.

In the working coil 150, current may or may not flow depending on whether the switching element is driven. When current flows through the working coil 150, magnetic fields are generated. The working coil 150 may heat a cooking appliance by generating the magnetic fields as the current flows.

One side of the working coil 150 is connected to a connection point of the switching element of the inverter 140, and the other side is connected to the resonance capacitor 160.

The switching element is driven by a driver (not shown), and a high-frequency voltage is applied to the working coil 150 while the switching element operates alternately by controlling a switching time output from the driver. In addition, since a turn on/off time of the switching element applied from the driver (not shown) is controlled in a manner that is gradually compensated, the voltage supplied to the working coil 150 is converted from a low voltage into a high voltage.

The resonance capacitor 160 may be a component to serve as a buffer. The resonance capacitor 160 controls a saturation voltage increasing rate during the turn-off of the switching element to affect an energy loss during the turn-off time.

The SMPS 170 refers to a power supply that efficiently converts power according to a switching operation. The SMPS 170 converts a DC input voltage into a voltage that is in the form of a square wave and then obtains a controlled DC output voltage through a filter. The SMPS 170 may minimize an unnecessary loss by controlling a flow of the power using a switching processor.

In the case of the cooktop 10 expressed by the circuit diagram illustrated in FIG. 3, a resonance frequency is determined by an inductance value of the working coil 150 and a capacitance value of the resonance capacitor 160. Then, a resonance curve may be formed around the determined resonance frequency, and the resonance curve may represent output power of the cooktop 10 according to a frequency band.

Next, FIG. 4 is a view illustrating output characteristics of the cooktop according to an embodiment of the present disclosure.

First, a Q factor (quality factor) may be a value representing sharpness of resonance in the resonance circuit. Therefore, in the case of the cooktop 10, the Q factor is determined by the inductance value of the working coil 150 included in the cooktop 10 and the capacitance value of the resonant capacitor 160. The resonance curve may be different depending on the Q factor. Thus, the cooktop 10 has different output characteristics according to the inductance value of the working coil 150 and the capacitance value of the resonant capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve represents a frequency, and a vertical axis represents output power. A frequency at which maximum power is output in the resonance curve is referred to as a resonance frequency f₀.

In general, the cooktop 10 uses a frequency in a right region based on the resonance frequency f₀ of the resonance curve. In addition, the cooktop 1 may have a minimum operating frequency and a maximum operating frequency, which are set in advance.

For example, the cooktop 10 may operate at a frequency corresponding to a range from the maximum operating frequency fₘₐₓ to the minimum operating frequency fₘᵢₙ. That is, the operating frequency range of the cooktop 10 may be from the maximum operating frequency fₘₐₓ to the minimum operating frequency fₘᵢₙ.

For example, the maximum operating frequency fₘₐₓ may be an IGBT maximum switching frequency. The IGBT maximum switching frequency may mean a maximum driving frequency in consideration of a resistance voltage and capacity of the IGBT switching element. For example, the maximum operating frequency fₘₐₓ may be 75 kHz.

The minimum operating frequency fₘᵢₙ may be about 20 kHz. In this case, since the cooktop 10 does not operate at an audible frequency (about 16 Hz to 20 kHz), noise of the cooktop 10 may be reduced.

Since setting values of the above-described maximum operating frequency fₘₐₓ and minimum operating frequency fₘᵢₙ are only examples, the embodiment of the present disclosure is not limited thereto.

When receiving a heating command, the cooktop 10 may determine an operating frequency according to a heating power level set by the heating command. Specifically, the cooktop 10 may adjust the output power by decreasing in operating frequency as the set heating power level is higher and increasing in operating frequency as the set heating power level is lower. That is, when receiving the heating command, the cooktop 10 may perform a heating mode in which the cooktop operates in one of the operating frequency ranges according to the set heating power.

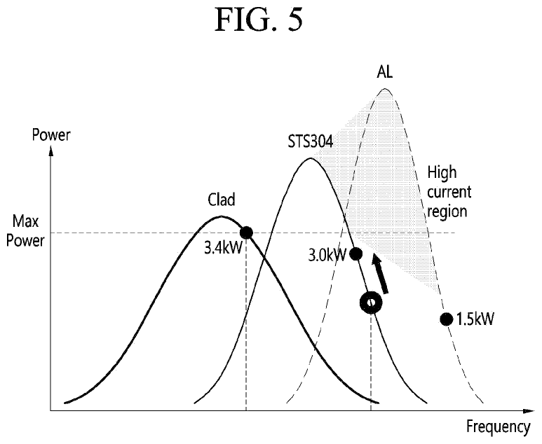

The cooktop 10 requires large current to improve heating efficiency of not only for the magnetic substance but also for the non-magnetic cooking container 1. This will be described in more detail with reference to FIG. 5.

FIG. 5 is a view illustrating output characteristics of the cooktop depending on a driving frequency for each type of cooking container.

In FIG. 5, clad is an example of a cooking container 1 that is a ferromagnetic material, STS304 is an example of a cooking container 1 that is a weak magnetic material, and AL is an example of a cooking container 1 that is a non-magnetic material.

As illustrated in FIG. 5, it is seen that a frequency for generating maximum power increases in order of the ferromagnetic material, the weak magnetic material, and the non-magnetic material. In addition, it is seen that high current is required at some driving frequencies for heating the weakly magnetic and non-magnetic cooking container 1.

Since the allowable current of the IGBT element is low as the frequency increases, the heating efficiency of the non-magnetic cooking container 1 may be limited.

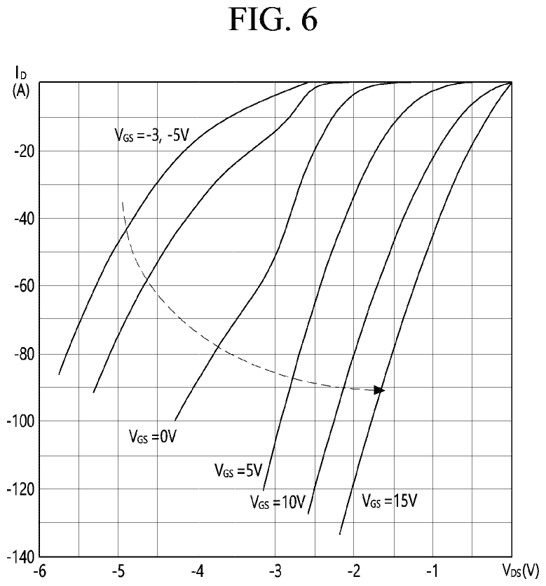

A SiC element may accept high current, but is characterized in that a voltage drop of an internal diode changes according to a magnitude of a gate voltage. Next, with reference to FIG. 6, the voltage drop characteristics of the internal diode according to the gate voltage of the SiC element will be described.

FIG. 6 is a graph illustrating the drop voltage of the internal diode according to the gate voltage of the SiC element.

Referring to an arrow in FIG. 6, it is seen that the voltage drop of the internal diode decreases as the gate voltage increases.

When the voltage drop decreases, reverse current increases, and power consumption greatly increases in a dead time section due to the reverse current. In relation to this, a more detailed explanation in connection with an operation of the inverter is as follows.

First, an operating section of the inverter 140 may be divided into a channel conduction section, a switch turn-off section, and a dead time section.

The channel conduction section may be a section in which current flows through a channel inside the SiC element.

The switch turn-off section may be a section in which a switch turn-off loss occurs during the turn-off section of the SiC element.

The dead time section may be a section for safe operation when the SiC element is turned on, and may be a section corresponding to a time difference between when the first switching element is turned off and before the second switching element is turned on. The dead time may be a section in which all of the plurality of switching elements are turned off. The dead time section may include a reverse conduction section in which the current flows through the internal diode.

Since the current flows through the internal diode in the reverse conduction section, especially when the cooking container 1 is made of the non-magnetic substance, high current may flow through the SiC element, and thus, a large power loss may occur in the reverse conduction section.

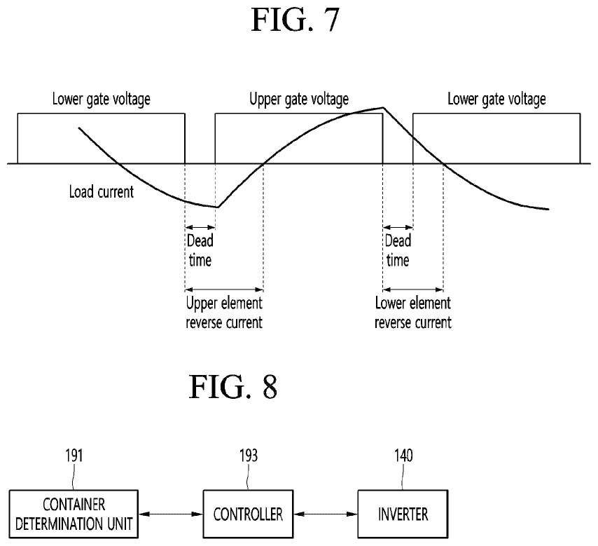

FIG. 7 is a view illustrating the dead time section and the reverse current generation section of the inverter according to an embodiment of the present disclosure.

In FIG. 7, a section in which both an upper gate voltage and a lower gate voltage are zero (0) may be a dead time section in which all of the plurality of switching elements are turned off. In addition, in the dead time section, a section in which the reverse current of the first switching element (upper element) flows, or the reverse current of the second switching element (lower element) flows may occur, and power consumption increases due to this reverse current.

In particular, the reverse current increases as the voltage drop decreases. As described above, the voltage drop decreases as the gate voltage increases.

A cooktop according to the related art is driven by fixing the dead time to time when driving the gate voltage. For example, the cooktop according to the related art drives the gate voltage by fixing the dead time to 1 μs.

However, in this case, as the frequency increases, a ratio occupied by the dead time in the operating section of the inverter increases, resulting in a further increase in power loss. However, if the dead time is simply reduced, there may be high possibility of distortion of a gate voltage waveform due to an influence of parasitic components in a high frequency region, and thus reliability of the inverter may be deteriorated.

Thus, the cooktop 10 according to an embodiment of the present disclosure intends to reduce a loss and improve a temperature rise problem of the switching element by varying dead time.

FIG. 8 is a control block diagram of the cooktop according to an embodiment of the present disclosure.

In FIG. 8, only one example of components that are necessary to explain the control method of the cooktop 10 according to an embodiment of the present disclosure is illustrated, and some of the components illustrated in FIG. 8 may be omitted, or other components that are not illustrated in FIG. 8 may be added.

The cooktop 10 may include a container determination unit 191, a controller 193, and an inverter 140.

The inverter 140 may include a plurality of switching elements driven to allow current to flow through the working coil 150. For example, the plurality of switching elements may be SiC elements, but is not limited thereto. For example, the plurality of switching elements may be gallium nitride (GaN) elements. That is, the plurality of switching elements may be wide band-gap (WBG) elements.

In this specification, it is assumed that the inverter 140 includes a first switching element (upper switching element) and a second switching element (lower switching element).

The container determination unit 191 may determine the type of cooking container 1. In more detail, the container determination unit 191 may determine a material of the cooking container 1.

The container determination unit 191 may determine the type of cooking container 1 in various manners.

The controller 193 may control the operation of the cooktop 10. The controller 193 may control each component constituting the cooktop 10, such as the inverter 140 and the container determination unit 191.

The controller 193 may adjust a duty of the plurality of switching elements provided in the inverter 140.

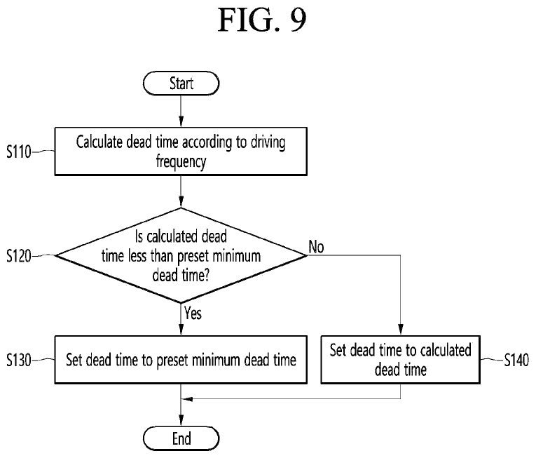

FIG. 9 is a flowchart illustrating an operating method of the cooktop according to a first embodiment of the present disclosure.

According to the first embodiment, a dead time may vary according to a driving frequency. Thus, the controller 193 may adjust the dead time based on the driving frequency of an inverter 140. Hereinafter, a method for varying dead time according to the driving frequency in the cooktop 10 will be described in detail.

The controller 193 may calculate the dead time according to the driving frequency (S110).

The dead time may be set to a value corresponding to a preset ratio based on the driving frequency. Thus, the controller 193 may calculate a preset ratio according to the driving frequency as the dead time.

According to an embodiment, the controller 193 may calculate the dead time whenever the driving frequency is changed. According to another embodiment, the controller 193 may change the driving frequency at each preset section.

Next, a method for calculating the dead time will be described through a case in which the preset ratio is 20% as an example.

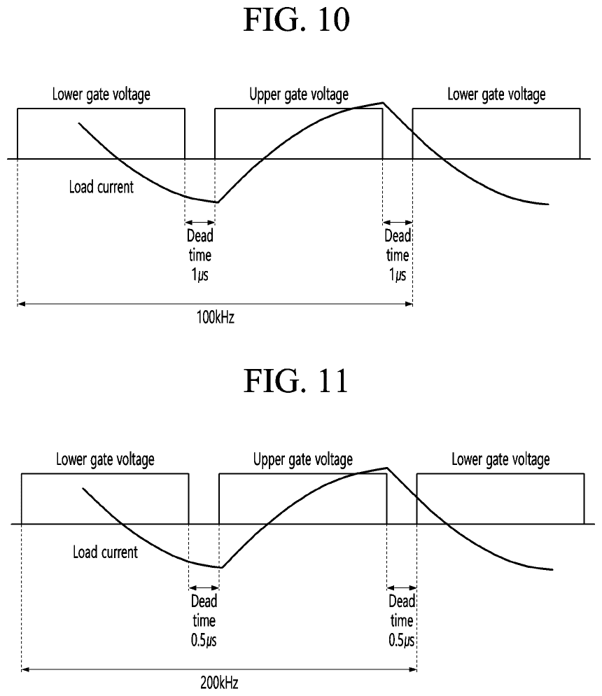

FIGS. 10 to 11 are views for explaining an example of the method for calculating the dead time in the cooktop according to the first embodiment of the present disclosure.

Referring to FIG. 10, since a section is 10 μs when the driving frequency is 100 kHz, the controller 193 may set 2 μs, which is 20% of the section, as the total dead time for one section, and thus, the dead time section for each switching element may be 1 μs.

In addition, referring to FIG. 11, since a section is 5 μs when the driving frequency is 200 kHz, the controller 193 may set 1 μs, which is 20% of the section, as the total dead time for one section, and thus, the dead time section for each switching element may be 0.5 μs.

As described above, when the preset ratio according to the driving frequency is adjusted to the dead time, the dead time section becomes shorter as the frequency increases, and thus, there is an advantage in reducing a loss.

FIG. 9 will be described again.

The controller 193 may determine whether the calculated dead time is equal to or less than a preset minimum dead time (S120).

Specifically, the controller 193 may set a minimum dead time in advance in order to minimize a case in which the dead time is excessively short. For example, the minimum dead time may be 0.2 μs, but since this is merely an example, it is not limited thereto.

If the calculated dead time is equal to or less than the preset minimum dead time, the controller 193 may set the dead time to the preset minimum dead time (S130).

When the calculated dead time is greater than the preset minimum dead time, the controller 193 may set the dead time as the calculated dead time (S14).

That is, if the calculated dead time exceeds a preset minimum dead time, the controller 193 may set the dead time as the calculated dead time.

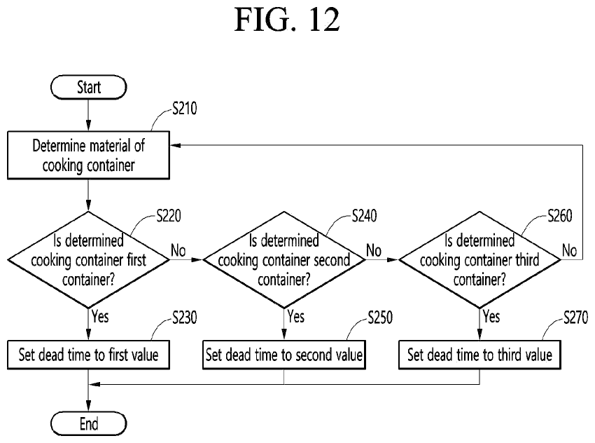

Next, FIG. 12 is a flowchart illustrating an operating method of the cooktop according to a second embodiment of the present disclosure.

According to the second embodiment, a dead time may vary depending on the type of cooking container 1. A controller 193 may adjust the dead time according to the type of cooking container 1. Hereinafter, a method in which the dead time in the cooktop 10 varies according to the cooking container 1 will be described in detail.

The controller 193 may determine a material of the cooking container 1 (S210).

For example, the controller 193 may acquire whether the cooking container 1 is made of magnetic or non-magnetic substance. As another example, the controller 193 may acquire whether the cooking container 1 is made of ferromagnetic, weakly magnetic, or non-magnetic substance. That is, the number of types of cooking containers 1 that is capable of being determined by the cooking container 1 is not limited. Hereinafter, for convenience of description, it is assumed that the controller 193 is capable of determining three types of materials of the cooking container 1.

The controller 193 may determine whether the determined cooking container 1 is a first container (S220).

When the determined cooking container 1 is the first container, the controller 193 may set the dead time to a first value (S230).

If the determined cooking container 1 is not the first container, the controller 193 may determine whether the determined cooking container 1 is a second container (S240).

When the determined cooking container 1 is the second container, the controller 193 may set the dead time to a second value (S250).

If the determined cooking container 1 is not the second container, the controller 193 may determine whether the determined cooking container 1 is a third container (S260).

If the determined cooking container 1 is the third container, the controller 193 may set the dead time to a third value (S270).

If the determined cooking container 1 is not the third container, the controller 193 may determine the material of the cooking container 1 again (S210).

Alternatively, if the determined cooking container 1 is not the third container, the controller 193 may set the dead time to a preset basic value (e.g., the first value).

In the above method, the first container may have magnetism greater than that of the second container, and the second container may have magnetism greater than that of the third container. That is, the first container may be made of a ferromagnetic material, the second container may be made of a weak magnetic material, and the third container may be made of a non-magnetic material. In addition, in this case, the first value may be greater than the second value, and the second value may be greater than the third value. For example, the first value may be 1 μs, the second value may be 0.7 μs, and the third value may be 0.5 μs. In summary, the dead time may be set longer as the magnetism of the container is stronger, and the dead time may be set shorter as the magnetism of the container is weaker. That is, the controller 193 may vary in dead time so that the dead time decreases as a driving frequency of the inverter 140 increases.

Since the cooktop 10 according to the first and second embodiments described above has the variable dead time, it is possible to be driven at the high frequency while minimizing the loss and heat generation of the switching element, and thus, there is an advantage in that the types of cooktops 1 that are capable of being heated are expanded to improve the output for non-magnetic materials. In addition, since the problem of the temperature rise of the switching element is minimized, the number and size of components of a cooling system may be reduced, and thus, the size of the cooktop 10 may be reduced.

In the present specification, the magnetic substance may mean a material having ferromagnetism (ferromagnetic substance), and the non-magnetic substance may include a material having weak magnetism other than the ferromagnetic substance (weak magnetic substance) and a material having no magnetism at all.

In addition, in the present specification, when the cooking container 1 is made of the magnetic substance, the expression of voltage/current/resistance/power, etc., is large (high)/small (low) means that the voltage/current/resistance/power, etc., is relatively large (high) or small (low) compared to the case in which the cooking container 1 is made of the non-magnetic substance, conversely, when the cooking container 1 is made of the non-magnetic substance, the expression of voltage/current/resistance/power, etc., is large (high)/small (low) means that the voltage/current/resistance/power, etc., is relatively large (high) or small (low) compared to the case in which the cooking container 1 is made of the magnetic substance.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1-10. (canceled)

11. An induction heating cooktop comprising:
a working coil;
an inverter comprising a plurality of switching elements, the inverter being configured to apply current to the working coil; and
a controller configured to adjust a duty cycle of each of the plurality of switching elements,
wherein a dead time in which all of the plurality of switching elements are turned off is variable.

12. The induction heating cooktop according to claim 11, wherein the controller is further configured to adjust the dead time based on a driving frequency of the inverter.

13. The induction heating cooktop according to claim 12, wherein the controller is further configured to adjust the dead time such that the dead time decreases as the driving frequency of the inverter increases.

14. The induction heating cooktop according to claim 12, wherein the controller is further configured to calculate a calculated dead time of the inverter according to the driving frequency.

15. The induction heating cooktop according to claim 14, wherein the controller is further configured to calculate the calculated dead time whenever the driving frequency is changed.

16. The induction heating cooktop according to claim 14, wherein the controller is further configured to set the dead time as the preset minimum dead time when the calculated dead time is less than or equal to a preset minimum dead time.

17. The induction heating cooktop according to claim 14, wherein the controller is further configured to set the dead time as the calculated dead time when the calculated dead time is greater than a preset minimum dead time.

18. The induction heating cooktop according to claim 11, further comprising an upper plate configured to support a cookware,
wherein the controller is further configured to adjust the dead time according to a type of the cooking container.

19. The induction heating cooktop according to claim 18, wherein the controller is further configured to:
set the dead time as a first value when the cooking container is a first type of container; and
set the dead time as a second value when the cooking container is a second type container different from the first type of container.

20. The induction heating cooktop according to claim 19, wherein, when the first type of container is made of a magnetic substance, and the second type of container is made of a non-magnetic substance, the first value is greater than the second value.

21. The induction heating cooktop according to claim 11, wherein the controller is further configured to calculate a calculated dead time based on a preset ratio according to a driving frequency of the inverter.

22. The induction heating cooktop according to claim 11, wherein the controller is further configured to calculate a calculated dead time of the inverter according to a driving frequency of the inverter.

23. The induction heating cooktop according to claim 22, wherein the controller is further configured to calculate the calculated dead time whenever the driving frequency is changed.

24. The induction heating cooktop according to claim 22, wherein the controller is further configured to set the dead time as the preset minimum dead time when the calculated dead time is less than or equal to a preset minimum dead time.

25. The induction heating cooktop according to claim 22, wherein the controller is further configured to set the dead time as the calculated dead time when the calculated dead time is greater than a preset minimum dead time.

26. An induction heating cooktop comprising:
an upper plate configured to support a cooking vessel;
a working coil configured to generate a magnetic field to heat the cooking vessel;
an inverter comprising a plurality of switching elements, the inverter being configured to apply current to the working coil; and
a controller configured to adjust a dead time of the inverter by changing a duty cycle of each of the plurality of switching elements,
wherein the dead time is adjusted based on a type of the cooking vessel.

27. The induction heating cooktop according to claim 26, wherein the controller is configured to:
set the dead time as a first value when the cooking container is a first type of container; and
set the dead time as a second value when the cooking container is a second type container different from the first type of container.

28. The induction heating cooktop according to claim 27, wherein, when the first type of container is made of a magnetic substance, and the second type of container is made of a non-magnetic substance, the first value is greater than the second value.

29. The induction heating cooktop according to claim 26, wherein the controller is further configured to calculate a calculated dead time of the inverter according to the driving frequency whenever the driving frequency is changed.

30. The induction heating cooktop according to claim 29, wherein, the controller is further configured to set the dead time as the preset minimum dead time when the calculated dead time is less than or equal to a preset minimum dead time, and
wherein the controller is further configured to set the dead time as the calculated dead time when the calculated dead time is greater than a preset minimum dead time.
